(19) United States
(12) Patent Application Publication
(10) Pub. No.: US 2026/0244977 A1
(43) Pub. Date: Aug. 20, 2026

(54) Concordance Based Artificial Intelligence Model

(71) Applicant: Michael Huff, Martinsburg, WV (US)

(72) Inventor: Michael Huff, Martinsburg, WV (US)

(21) Appl. No.: 19/054,793

(22) Filed: Feb. 15, 2025

(51) Int. Cl. G06N 20/00

(52) U.S. Cl. CPC G06N 20/00

(57) ABSTRACT

The concordance based artificial intelligence model utilizes human or program defined keywords to analyze data and create output based on its analysis. This analysis is comprised of layers of program generated concordances and concatenations of concordances to produce content from its source data that is contextually relevant to queries. The concordance based artificial intelligence model is immune from the “hallucinations” phenomenon found in neural network based artificial intelligence models. It mimics human memory in its operation by producing a full forensic path of each of its operations in the form of text files that are saved for future use and are used to train the model over time.

### BACKGROUND OF THE INVENTION

### Field of the Invention

Cooperative Patent Classification (CPC) B60G2600/1876 3 Artificial Intelligence.

### Background

Existing commercially-available artificial intelligence systems are based on programmed neural networks and train on large and unrelated datasets. These Large Language Models (LLM) use statistical algorithms to produce original content which mimics natural language. However they suffer from a defect known as “hallucinations” when queried. A hallucination produced by an LLM has been defined as, “generating content that appears factual but is ungrounded.” (arXiv:2401.01313 [cs.CL]). This known defect limits the potential scope of application for artificial intelligence by randomly producing falsehoods, inaccuracies and harmful content. The subject of this patent application is a different artificial intelligence model that does not use neural networks as its basis, does not use statistical algorithms to generate content and can be trained on as large or as small a dataset as desired and as such is immune to the phenomenon of hallucinations known to afflict existing LLM artificial intelligence systems.

### SUMMARY OF THE INVENTION

The concordance based artificial intelligence model is a model for a computer program for producing artificial intelligence using layers of concordances and concatenations derived from a user-defined library of existing text content to generate new text content in response to queries of the system. This method mimics human memory in its interaction with text content to produce new content that is relevant to the intent and context of the queries made of it.

### DETAILED DESCRIPTION OF THE INVENTION

The concordance based artificial intelligence model program was written in Python v3.11 to validate proof of concept and verify its practical application. It generates a graphical user interface (GUI) containing a blank line at the top labeled ‘Query’ in which a user types in their query for the system. To the right is a button labeled ‘Enter’ that is selected to apply the program to the content of the user query. At the bottom of the GUI is a large empty space where, after the program has completed its operations, the query results are displayed to the user.

### Concordance Based Artificial Intelligence Model Structure

Folder 1: Home of the program file(s). All files created by the program begin here and are distributed to other folders by category
Folder 2: Contains archive of all forms of external text data (books, records, essays, articles, quotes, etc.)
Folder 3: Depository for concordances as text files, generated from the contents of Folder 2 in conjunction with user interaction with the program graphical user interface and/or automated external and internal search queries
Folder 4: Depository for concatenated concordances generated from the contents of Folder 3 as text files
Folder 5: Depository for custom concordances and concatenated concordances generated from the contents of Folder 4 as text files and the parameters set by the program

As soon as the ‘Enter’ button is selected, the program uses the keywords from the user query to locate and return concordances from the user-designated data located in Folder 2. From this point, a full forensic record of the query is produced by the program. A text file is created for each concordance, which are then saved to Folder 3. These relevant concordances derived from the keywords of the user query are concatenated and this concatenation is saved as a text file in Folder 4. New and prior concatenations of concordances based on the relevant keywords are further refined through another action of concordance and concatenation of text files in Folder 4 to produce a final query result, which is saved as a text file in Folder 5. The contents of this last text file are then displayed to the user as the system response to their query. Each text file produced by the program is named to contain the keywords that led to its creation along with a random and unique string of characters. In this way each query contributes directly to training the model by building its physical memory in the form of categorized text files that can be used to further refine the model, its program and the contextual accuracy of query results. The GUI also displays a button marked “SGL” which stands for Self-Guided Learning. If a user selects this button, the program will generate a keyword on its own and perform all of the functions outlined above. It will do this for a program-specified number of times, generating keywords randomly from the top words found in a frequency distribution of words from the data contents of Folder 4. When the program has completed the number of operations it was programmed to perform, the words, “Self-Guided Learning complete” will populate in the output box of the GUI. Attached file “ConcordanceBasedAIModelExampleCode.txt” demonstrates the contents from this detailed description and represents the best mode of operation of the concordance based artificial model at the time of filing.

1. A method for creating an artificial intelligence model using programs, applications or other forms of software on a computer, comprising:
the generation of concordances from data using keywords;
the concatenation of generated concordances;
the concatenation of generated concatenated concordances; and
output derived from a combination of these concordances, concatenated concordances and/or concatenations of concatenated concordances alone or in combination with the output of other models, programs, applications or other forms of software on a computer.
